(19) United States
(12) Patent Application Publication
(10) Pub. No.: US 2011/0065387 A1
(43) Pub. Date: Mar. 17, 2011

(54) ANTENNA APPARATUS AND COMMUNICATION APPARATUS

(75) Inventors: Kouji Hayashi, Akishima-shi (JP); Akihiro Tsujimura, Kokubunji-shi (JP); Hiroshi Shimasaki, Kunitachi-shi (JP)

(73) Assignee: KABUSHIKI KAISHA TOSHIBA, Tokyo (JP)

(21) Appl. No.: 12/725,703

(22) Filed: Mar. 17, 2010

(30) Foreign Application Priority Data
Sep. 15, 2009 (JP) 2009-213623

(51) Int. Cl. H04B 7/00; G08B 13/14

(52) U.S. Cl. 455/41.2; 340/572.7

(57) ABSTRACT

A communication apparatus includes a coupler for first wireless communication and a loop antenna for second wireless communication. The coupler is electrically asymmetrical, and arranged in such a manner that a feed point substantially coincides with a center position of the second wireless communication.

### CROSS-REFERENCE TO RELATED APPLICATIONS

This application is based upon and claims the benefit of priority from prior Japanese Patent Application No. 2009-213623, filed Sep. 15, 2009, the entire contents of which are incorporated herein by reference.

### BACKGROUND OF THE INVENTION

1. Field of the Invention

The present invention relates to an antenna apparatus and a communication apparatus for different wireless communication systems.

2. Description of the Related Art

Conventionally, contactless communication systems such as a FeliCa and a mobile FeliCa have been suggested. The contactless communication systems have been utilized in a variety of uses, such as an RFID smartcard bus or train pass, an employee ID card and electronic payment. In the FeliCa system, a loop-shaped antenna (hereinafter, simply referred to as a loop antenna) is arranged on an REID smartcard or the like (in the mobile FeliCa system, a loop antenna is arranged in a mobile phone or the like). The RFID smartcard is usually not provided with a feed point, but when communications are established on the FeliCa, a carrier (13.56 MHz) transmitted from a reader/writer causes electromagnetic induction, which generates power in the loop antenna. The power is consumed to start up a communication unit (such as a CPU) connected to the loop antenna of the RFID smartcard. In the mobile FeliCa system, power is supplied directly from the circuit board of the mobile phone or the like to the loop antenna.

On the other hand, as described in Jpn. Pat. Appln. KOKAI Publication No. 2008-182714, very short range wireless communication systems are being developed. TransferJet is one of the very short range wireless communication systems that is now in the process of standardization. In the TransferJet system, a coupling electrode of a coupler generates an induced electric field, and communications are conducted by use of this induced electric field. A communication distance of several centimeters is assumed for TransferJet, and thus the system is advantageous in various aspects including security. Furthermore, TransferJet can achieve a high-speed transmission (560 Mbps at the maximum), and therefore is suitable for transmission of large volumes of data such as content.

In the following explanation, a contactless communication system, FeliCa, mobile FeliCa, a very short range wireless communication system, TransferJet and the like may be referred to as wireless communication systems for the sake of simplicity. In other words, a contact less communication system, FeliCa and mobile FeliCa may sometimes be referred to as wireless communication systems, or a very short range wireless communication system and TransferJet may sometimes be referred to as wireless communication systems.

Use of a contactless communication system such as mobile FeliCa together with a very short range wireless communication system such as TransferJet is expected in the near future. For example, when purchasing content, electronic payment may be made through mobile FeliCa, and the data may be downloaded through TransferJet. To respond to such use, the loop antenna of the mobile FeliCa and the coupler of the TransferJet need to be arranged close to each other in the casing (or outside the casing) of a communication apparatus (e.g. a mobile phone). However, unless the shapes and positions of the coupler and the loop antenna are carefully determined, adverse conditions such as the coupler interfering wireless communications utilizing the loop antenna may be incurred.

The present invention has been conceived to offer suitable arrangement of the coupler and the loop antenna for different wireless communication systems.

### BRIEF SUMMARY OF THE INVENTION

According to an aspect of the invention, there is provided a communication apparatus comprising a coupler for first wireless communication and a loop antenna for second wireless communication, wherein: the coupler is electrically asymmetrical, and arranged in such a manner that a feed point substantially coincides with a center position or the second wireless communication.

According to another aspect of the invention, there is provided an antenna apparatus comprising a coupler for first wireless communication and a loop antenna for second wireless communication, wherein: the coupler is electrically asymmetrical, and arranged in such a manner that a feed point substantially coincides with a center position of the second wireless communication.

### BRIEF DESCRIPTION OF THE SEVERAL VIEWS OF THE DRAWING

FIG. 1 is a diagram showing an example of a loop antenna taking a symmetrical form.

FIG. 2 is a diagram showing an example of an electrically symmetrical coupler.

FIG. 3 is a diagram showing an example arrangement of the loop antenna of FIG. 1 and the coupler of FIG. 2.

FIG. 4 is a diagram showing an example of an electrically asymmetrical coupler.

FIG. 5 is a diagram showing an example arrangement of the loop antenna of FIG. 1 and the coupler of FIG. 4.

FIG. 6A is a diagram explaining simulation conditions for examining effects of the arrangement of the coupler and the loop antenna in the communication apparatus according to the first embodiment.

FIG. 6B is a graph indicating results of the simulation under the simulation conditions of FIG. 6A.

FIG. 7A is a diagram explaining simulation conditions for examining effects of the arrangement of the coupler and the loop antenna in the communication apparatus according to the first embodiment.

FIG. 7B is a graph indicating results of the simulation under the simulation conditions of FIG. 7A.

FIG. 8 is a diagram showing an example of an electrically asymmetrical loop antenna.

FIG. 9 is a diagram showing an example arrangement of the loop antenna of FIG. 8 and the coupler of FIG. 4.

FIG. 10A is a diagram explaining simulation conditions for examining effects of the arrangement of the coupler and the loop antenna in the communication apparatus according to the second embodiment.

FIG. 10B is a graph indicating results of the simulation under the simulation conditions of FIG. 10A.

FIG. 11 is a diagram showing an example implementation of the coupler and the loop antenna in the communication apparatus according to the first and second embodiments.

FIG. 12 is a cross section of the structure of FIG. 11.

FIG. 13 is a diagram showing an example implementation of the coupler and the loop antenna in the communication apparatus according to the first and second embodiments.

FIG. 14 is a block diagram of an example of the communication apparatus according to the first embodiment.

### DETAILED DESCRIPTION OF THE INVENTION

Embodiments of the present invention will be explained below with reference to the attached drawings.

### First Embodiment

A communication apparatus according to the first embodiment of the present invention comprises a first wireless communication unit and a second wireless communication unit. The first wireless communication unit here is associated with a wireless communication system utilizing a coupler such as TransferJet. Further, the second wireless communication unit is associated with a wireless communication system utilizing a loop antenna such as FeliCa and mobile FeliCa.

The implementation of the communication apparatus according to the present embodiment is not particularly limited. The communication apparatus can be a device such as a mobile phone and a mobile PC that comprises any communication unit other than the first and second wireless communication units (e.g., a voice communication unit and an airwave reception unit), or it ran be a device such as a portable music player that does not comprise any communication unit other than the first and second wireless communication units. In other words, the communication apparatus can be any device comprising the first and second wireless communication units.

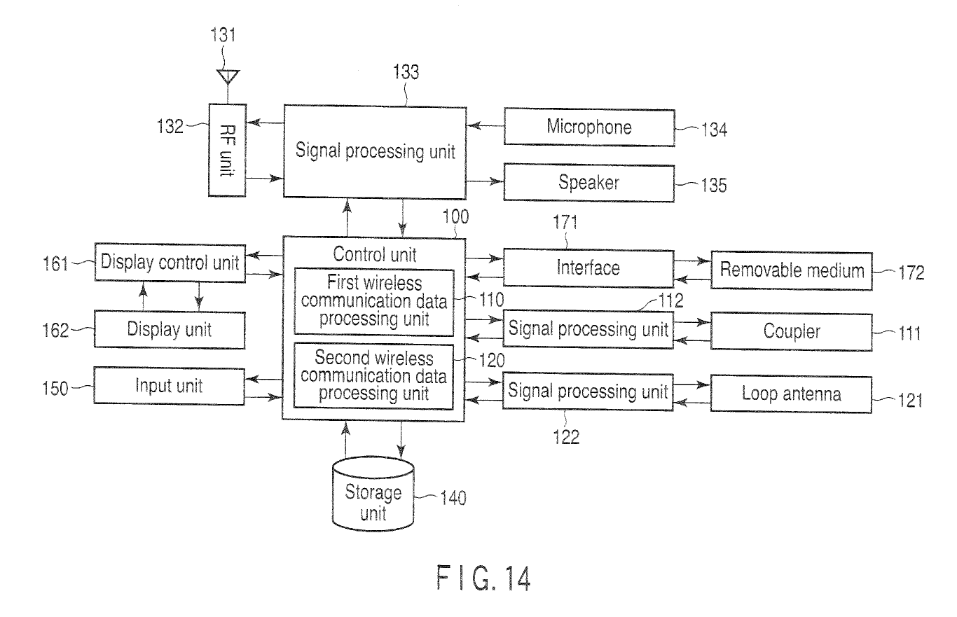

The communication apparatus according to the present embodiment may be a mobile phone as illustrated in FIG. 14, comprising a control unit 100, coupler 111, a signal processing unit 112, a loop antenna 121, a signal processing unit 122, an antenna 131, a RF unit 132, a signal processing unit 133, a microphone 134, a speaker 135, a storage unit 140, an input unit 150, a display control unit 161, a display unit 162, an interface 171 and a removable medium 172.

The control unit 100 comprises a first wireless communication data processing unit 110 and a second wireless communication data processing unit 120. The first wireless communication data processing unit 110 processes the first reception data received from the signal processing unit 112 and also generates the first transmission data. The second wireless communication data processing unit 120 processes the second reception data received from the signal processing unit 122 and also generates the second transmission data.

The coupler 111 conducts the first wireless communication to receive a first reception signal and transmit a first transmission signal. The signal processing unit 112 performs signal processing to convert the first reception signal received from the coupler 111 to the first reception data, and also to convert the first transmission data received from the first wireless communication data processing unit 110 to the first transmission signal. In the example of FIG. 14, all or part of the first wireless communication data processing unit 110, the coupler 111 and the signal processing unit 112 correspond to the first wireless communication unit.

The loop antenna 121 conducts the second wireless communication to receive a second reception signal and transmit a second transmission signal. The signal processing unit 122 performs signal processing to convert the second reception signal received from the loop antenna 121 to the second reception data and also to convert the second transmission data received from the second wireless communication data processing unit 120 to the second transmission signal. In the example of FIG. 14, all or part of the second wireless communication data processing unit 120, the loop antenna 121 and the signal processing unit 122 correspond to the second wireless communication unit.

The RF unit 132 up-coverts a transmission signal output by the signal processing unit 133 to a radio-frequency band, and transmits the signal by way of the antenna 131 to a base station in a mobile communications network that is not shown in the drawings. The RF unit 132 also receives a RF signal from the base station by way of the antenna 131 and down-converts it to a baseband signal.

The signal processing unit 133 operates in accordance with an instruction issued by the control unit 100. The signal processing unit 133 converts an audio signal input through the microphone 134 to transmission data, and generates a transmission signal by modulating a carrier wave, based on the transmission data. The signal processing unit 133 also demodulates a baseband signal input by the RF unit 132 to obtain reception data, obtains an audio signal by decoding the reception data and outputs the signal through the speaker 135.

The storage unit 140 is a storage medium such as a random access memory (RAM), a read only memory (ROM) and a hard disk, which stores control programs for the control unit 100, control data, various kinds of data created by the user, control data related to the removable medium 172, and the like. The input unit 150 includes a user interface incorporating input devices such as a plurality of keys (such as a numeric keypad) and a touch panel to receive a request from the user.

The display control unit 161 drives the display unit 162 in accordance with an instruction issued by the control unit 100, and causes the display unit 162 to display an image signal based on the display data supplied by the control unit 100. The display unit 162 may be a liquid crystal display or an organic EL display. The interface 171 establishes a physical or electrical connection for the removable medium 172 to exchange data, and is controlled by the control unit 100.

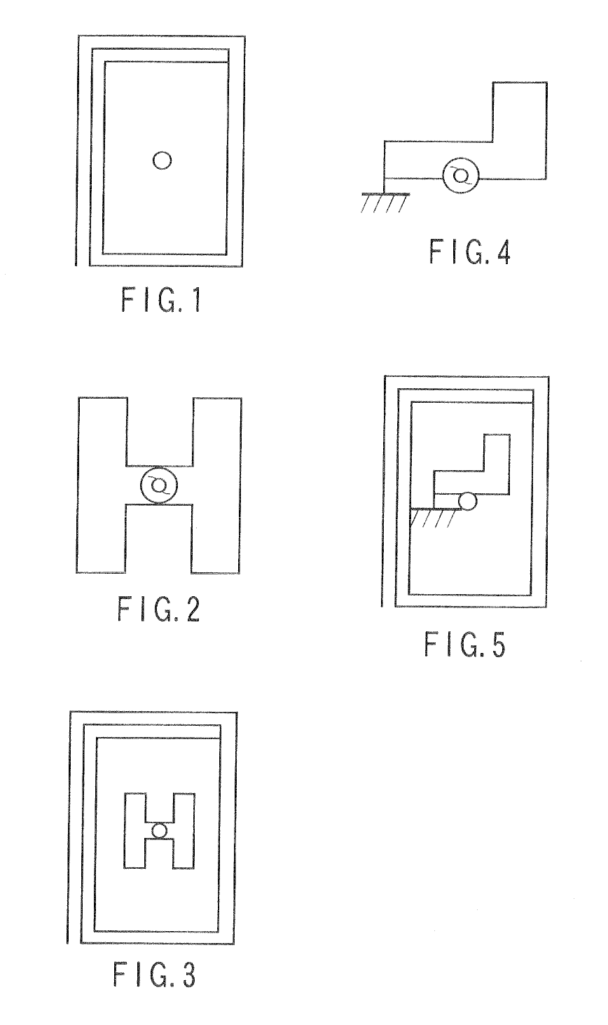

The loop antenna incorporated in the second wireless communication unit may take a symmetrical form as illustrated in FIG. 1. The loop antenna of FIG. 1 is shaped substantially into a rectangle. The circle in FIG. 1 indicates an estimated position of the communication center of the second wireless communication unit adopting the loop antenna of FIG. 1. The communication center represents the position at which the communication of the highest quality can be established or an effective area of communications including such a position (e.g. FeliCa mark).

Various methods for estimating the communication center can be employed. According to the present embodiment, it is estimated that the communication center is present at the geometrical gravity point of the form of the loop antenna. By assuming the geometrical gravity point of the form of the loop antenna as the communication center, an analysis for determining the actual communication center of the loop antenna can be omitted. The gravity point does no require precision here. For example, the gravity point of a form similar to that of the loop antenna can be accepted as the gravity point of the form of the loop antenna. The above estimation method is not intended to be presented here to exclude other methods. Any estimation method that can be considered appropriate by a person skilled in the art may be employed for estimating the communication center of the second wireless communication unit in the communication apparatus according to the present embodiment.

Because the loop antenna of FIG. 1 is a rectangle, the geometrical gravity point of this form can be easily derived. For example, the geometrical gravity point can be obtained from an intersection point of the diagonals of the rectangle. By assuming the intersection point of the diagonals of the rectangle as the communication center, an actual analysis for determining the communication center of the loop antenna can be omitted. Moreover, the loop antenna of FIG. 1 may be shaped into any other symmetrical form, such as an ellipse. The ellipse can be a circle. When the loop antenna is an ellipse, the geometrical gravity point can be derived from an intersection point of its long and short axes. By assuming the intersection point of the long and short axes of the ellipse as a communication center, an actual analysis for determining the communication center of the loop antenna can be omitted. Furthermore, when the loop antenna takes a form symmetrical with respect to a point, the geometrical gravity point can be derived from this point. On the other hand, when the loop antenna takes a form symmetrical with respect to a line, it can be considered that the geometrical gravity point is present on the line of symmetry.

The coupler generally adopted in the first wireless communication unit may be designed as illustrated in FIG. 2. The coupler of FIG. 2 takes a symmetrical form, around the center of which the feed point is provided. In other words, the coupler of FIG. 2 is electrically symmetrical. The communication center of the first wireless communication unit falls substantially on the position of the power supply unit, regardless of the shape of the coupler. In a similar manner to FIG. 1, the estimated position of the communication center (i.e. the position of the feed point) is indicated by a circle in the coupler of FIG. 2.

Here, in the communication apparatus according to the present embodiment, the arrangement of the coupler for the first wireless communication unit and the loop antenna for the second wireless communication unit has to be carefully considered. When attention is given to the convenience of the user, it is preferable that the communication centers of the two units substantially coincide with each other, as Illustrated in FIG. 3. When the arrangement is made in such a manner that the two communication centers substantially coincide with each other, the coupler and the loop antenna can be designed with small footprints, and the user can use both the first and second wireless communication units at the time of purchasing content or the like. To use the first and second wireless communication units together means to simply use the two units in parallel, or to shift the use from one unit seamlessly to the other unit (without requiring any additional user operation). However, in the arrangement of FIG. 3, the coupler (i.e., a metal plate) is provided near the communication center of the second wireless communication unit. Because a magnetic flux concentrates near the communication center of the second wireless communication unit, the metal plate arranged in this area would disturb the ambient magnetic flux, which would degrade the communication quality of the second wireless communication unit.

For this reason, in the communication apparatus according to the present embodiment, an electrically asymmetrical coupler is adopted in place of an electrically symmetrical coupler as illustrated in FIG. 2. More specifically, an electrically asymmetrical coupler can be obtained by arranging the feed point as a position shifted from the geometrical center of a symmetrical coupler. If the coupler takes an asymmetrical form, the coupler becomes electrically asymmetrical regardless of the position of the feed point. For example, a coupler of an asymmetrical form as illustrated in FIG. 4 may be adopted as an electrically asymmetrical coupler. The coupler of FIG. 4 is provided with a feed point in its edge portion, and a grounding point is provided near the feed point. As set forth above, the communication center of the first wireless communication unit coincides substantially with the position of the feed point, regardless of the shape of the coupler. Thus, it can be assumed also in the coupler of FIG. 4 that the communication center of the first wireless communication unit is at the position of the feed point which is arranged in the edge portion. In FIG. 4, the communication center of the first wireless communication unit is indicated by a circle in the same manner as the above.

In the communication apparatus according to the present embodiment, the loop antenna of FIG. 1 and the coupler of FIG. 4 are arranged as illustrated in FIG. 5. In other words, in the arrangement of FIG. 5, the coupler of FIG. 4 and the loop antenna of FIG. 1 are arranged in such a manner that the feed point of the coupler and the geometrical gravity point of the shape of the loop antenna substantially coincide with each other (i.e., the communication centers of the first and second wireless communication units substantially coincide with each other). In comparison with the arrangement of FIG. 3, the area of the coupler (i.e., the metal plate) covering the center area of the second wireless communication unit is reduced in the arrangement of FIG. 5. Hence, with the arrangement of FIG. 5, an adverse effect of the coupler to the second wireless communication unit can be suppressed in comparison with the arrangement of FIG. 3.

In the following description, two simulations are presented in order to examine the influence of the metal plate arranged near the geometrical gravity point of the loop antenna upon the second wireless communication unit.

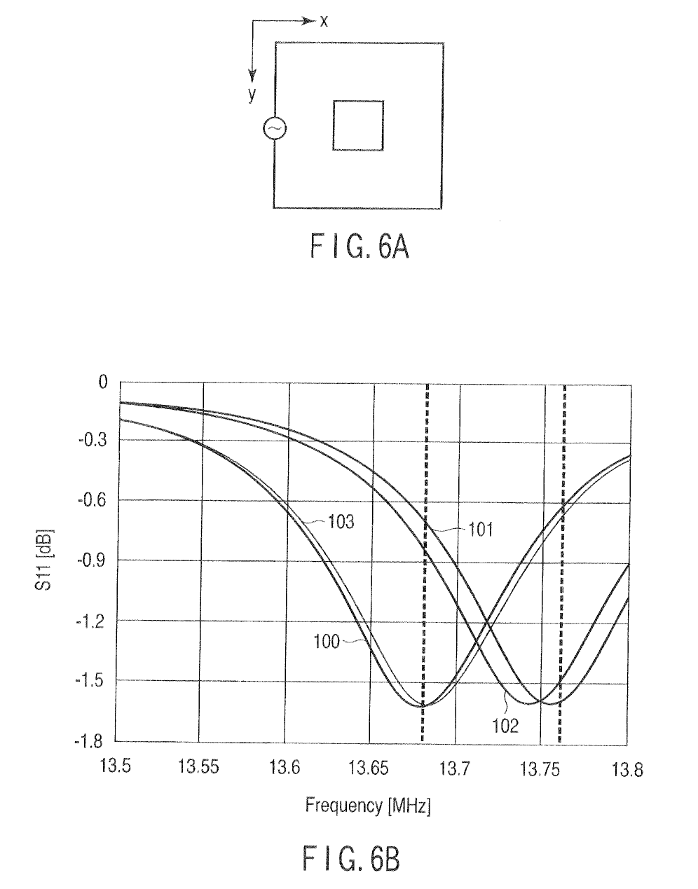

In the first simulation, the target loop antenna is shaped into a square of side 20 mm, as illustrated in FIG. 6A. The loop antenna of FIG. 6A is provided with a feed point near the middle of the left edge. In the first simulation, the change of the resonance frequency is measured by changing the position of a 6-mm-square metal plate on the loop antenna of FIG. 6A. In FIG. 6B, 100 represents frequency characteristics of the loop antenna without a metal plate; 101 represents frequency characteristics of the loop antenna with the metal plate at its center; 102 represents frequency characteristics of the loop antenna with the metal plate arranged at a position shifted +3 mm in the x-direction from the center of the loop antenna; and 103 represents frequency characteristics of the loop antenna with the metal plate arranged at a position shifted −3 mm in the y-direction from the center of the loop antenna. When a metal plate is not arranged on the loop antenna, the resonance frequency is about 13.68 MHz. When a metal plate is arranged at the center of the loop antenna, the resonance frequency is about 13.76 MHz. On the other hand, when the metal plate is arranged at a position shifted +3 mm in the x-direction and a position shifted −3 mm in the y-direction from the center of the loop antenna, the resonance frequencies are about 13.74 and 13.68 MHz, respectively. The first simulation shows that, in comparison with the metal plate arranged at the center of the loop antenna, the change of the resonance frequency can be suppressed when the metal plate is shifted from the center. It can be considered that this is because the area of the metal plate covering the center of the loop antenna is reduced.

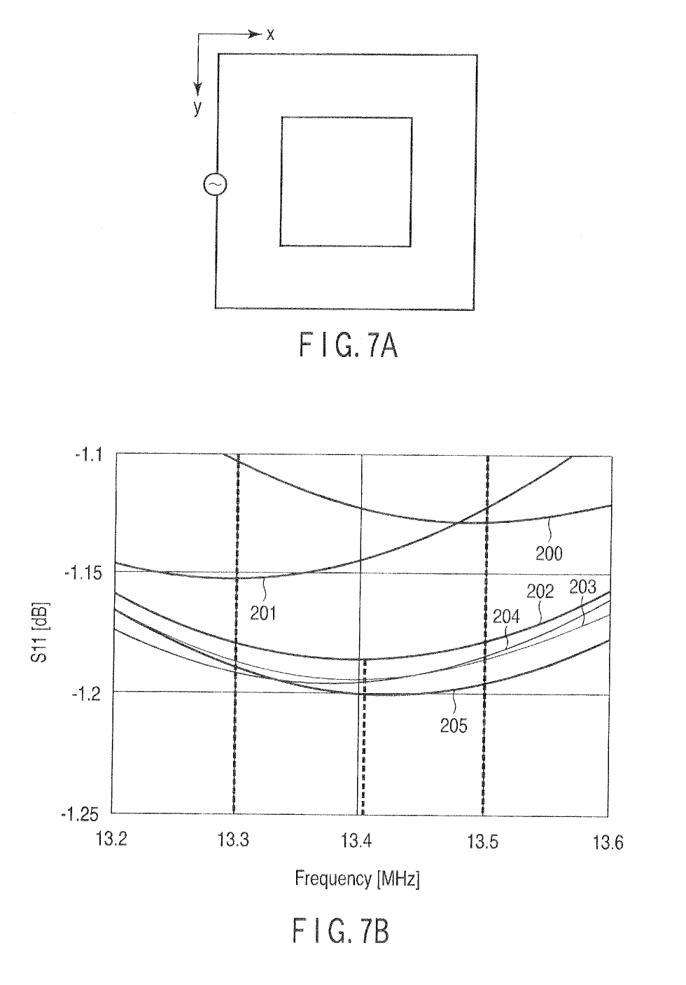

Next, in the second simulation, the target loop antenna of FIG. 7A is a square of side 33 mm. The loop antenna of FIG. 7A is provided with a feed point near the middle of its left edge. In the second simulation, the change of the resonance frequency of the loop antenna of FIG. 7A is measured by changing the position of a 15-mm-square metal plate arranged thereon. In FIG. 7B, 200 represents frequency characteristics of the loop antenna without a metal plate; 201 represents frequency characteristics of the loop antenna with a metal plate at its center; 202 represents frequency characteristics of the loop antenna with the metal plate arranged at a position shifted +7.5 mm in the x-direction from the center of the loop antenna; 203 represents frequency characteristics of the loop antenna with the metal plate arranged at a position shifted −7.5 mm in the x-direction from the center of the loop antenna; 204 represents frequency characteristics of the loop antenna with the metal plate arranged at a position shifted +7.5 mm in the y-direction from the center of the loop antenna; and 205 represents frequency characteristics of the loop antenna with a metal plate arranged at a position shifted −7.5 mm in the y-direction from the center of the loop antenna loop antenna. Similarly to the results of the first simulation, the second simulation shows that the change of the resonance frequency can be suppressed when the metal plate is shifted from the center of the loop antenna, in comparison with the arrangement of the metal plate at the center of the loop antenna.

In this manner, by reducing the area of the coupler covering the center of the second wireless communication unit even if the electrical symmetry of the coupler is disturbed, the adverse effect of the coupler upon the second wireless communication unit can be suppressed. The feed point does not always have to be arranged at the edge portion as in the coupler of FIG. 4 (i.e., the feed point does not have to be arranged such that the electrical symmetry is disturbed most). In other words, the positional adjustment of the feed point of the coupler can be made through the trade-off with respect to the effect of the coupler upon the second wireless communication unit.

The consideration of the position of the feed point in the coupler will be presented below, based on the simulations.

In the above explanation, the feed point of the coupler should be arranged so as to substantially coincide with the communication center of the second wireless communication unit. However, the degree of this coincidence may vary to some extent. The feed point of the coupler that is brought to substantially coincide with the communication center of the second wireless communication is originally intended to reduce the footprints of the coupler and the loop antenna, while allowing the first and second wireless communication units to be used together. However, simply by bringing the two units very close to each other, the first and second wireless communication units can be used together without causing any problem. Furthermore, the need for smaller footprints of the coupler and the loop antenna is variable, depending on the actual design of the communication apparatus. For this reason, according to the embodiments of the present invention, the arrangement of the feed point of the coupler substantially coinciding with the communication center of the second wireless communication unit suggests that the first and second wireless communication units are brought close enough to each other to use the two units together.

As mentioned above, in the communication apparatus according to the present embodiment, the electrically asymmetrical coupler and the loop antenna taking a symmetrical form are arranged in such a manner that the feed point of the coupler substantially coincides with the geometrical gravity point of the symmetrical loop antenna. Thus, in the communication apparatus according to the present embodiment, the area of the metal plate covering the center area of the loop antenna can be reduced, and therefore the adverse influence of the coupler upon the wireless communication unit adopting the loop antenna can be suppressed. For this reason, in the communication apparatus according to the present embodiment, because the communication centers of the first wireless communication unit incorporating the coupler and the second wireless communication unit incorporating the loop antenna are substantially in agreement with each other, the footprints of the coupler and the loop antenna can be reduced, and the user can use the first and second wireless communication units together at the time of purchasing content or the like.

### Second Embodiment

The communication apparatus according to the second embodiment of the present invention is different from the aforementioned communication apparatus according to the first embodiment in the use of an asymmetrical loop antenna. In the following description, differences between the present embodiment and the first embodiment will be focused on, and overlapping portions will be omitted from the description.

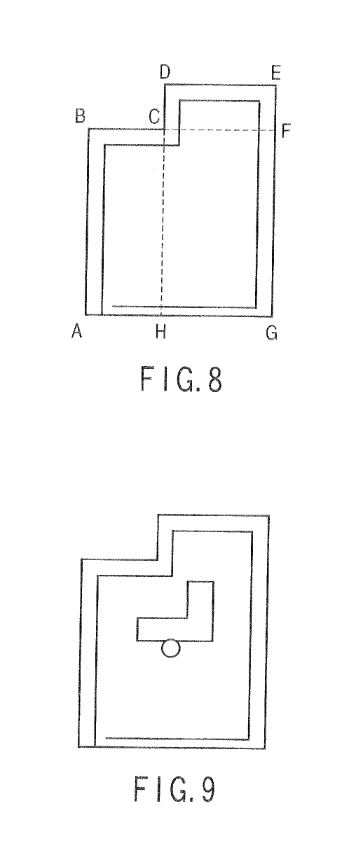

In the communication apparatus according to the present embodiment, the loop antenna incorporated in the second wireless communication unit may be shaped into an asymmetrical form as illustrated in FIG. 8. The circle in FIG. 8 indicates the position estimated as the communication center of the second wireless communication unit incorporating the loop antenna of FIG. 8. Various methods are applicable for estimating the position of the communication center. According to the first embodiment, the geometrical gravity point of the form of the loop antenna is assumed as the communication center. This method is applicable to the present embodiment, and by assuming the geometrical gravity point of the form of the loop antenna as the communication center, an actual analysis for determining the communication center of the loop antenna can be omitted. There is a problem, however, that it is not as easy to derive, the geometrical gravity point of an asymmetrical form as that of a symmetrical form. For this reason, according to the present embodiment, a simplified method of estimating the geometrical gravity point of the asymmetrical loop antenna is suggested.

Although the loop antenna of FIG. 8 is asymmetrical, rectangles BFGA and DEGH can be cut out along cutout lines such as line segments C-F and C-H, respectively. Because the rectangles BFGA and DEGH both take symmetrical forms, their geometrical gravity points can be easily derived (for example, by finding an intersection point, of the diagonals). According to the present embodiment, the geometrical gravity point of a cut-out form is assumed as the actual geometrical gravity point of the asymmetrical loop antenna (i.e., the communication center of the second wireless communication unit). However, because various symmetrical forms can be cut out of an asymmetrical form, a principle for selecting which one of the symmetrical forms should be cut out is needed. According to the present embodiment, a form having the largest area among the symmetrical forms that can be cut out of the asymmetrical form of the loop antenna should be cut out. In the loop antenna of FIG. 8, for example, the rectangle BFGA should be cut out along the cutout line C-F, and no other form should be cut out along the cutout line C-H or any other cutout line. The geometrical gravity point of the cut-out rectangle BFGA (in other words, the intersection point of the diagonals B-G and F-A) is assumed as the communication center of the loop antenna of FIG. 8. By assuming the geometrical gravity point of the largest cut-out form (e.g., the intersection point, of the diagonals of the rectangle) as the communication center, an actual analysis for determining the communication center of the loop antenna can be omitted. Then, as illustrated in FIG. 9, for example, the asymmetrical coupler of FIG. 4 is arranged in such a manner that the feed point of the coupler substantially coincides with the communication center of the second wireless communication unit adopting the loop antenna of FIG. 8.

This estimation method is applicable to a loop antenna of any asymmetrical form other than that of FIG. 8. In addition, a cutout line may be a straight line or a curve, or a combination thereof, depending on a form that is to be cut out.

In a similar manner to the first, embodiment, a simulation will be presented below to examine the influence of the metal plate arranged near the geometrical gravity point of the loop antenna upon the second wireless communication unit.

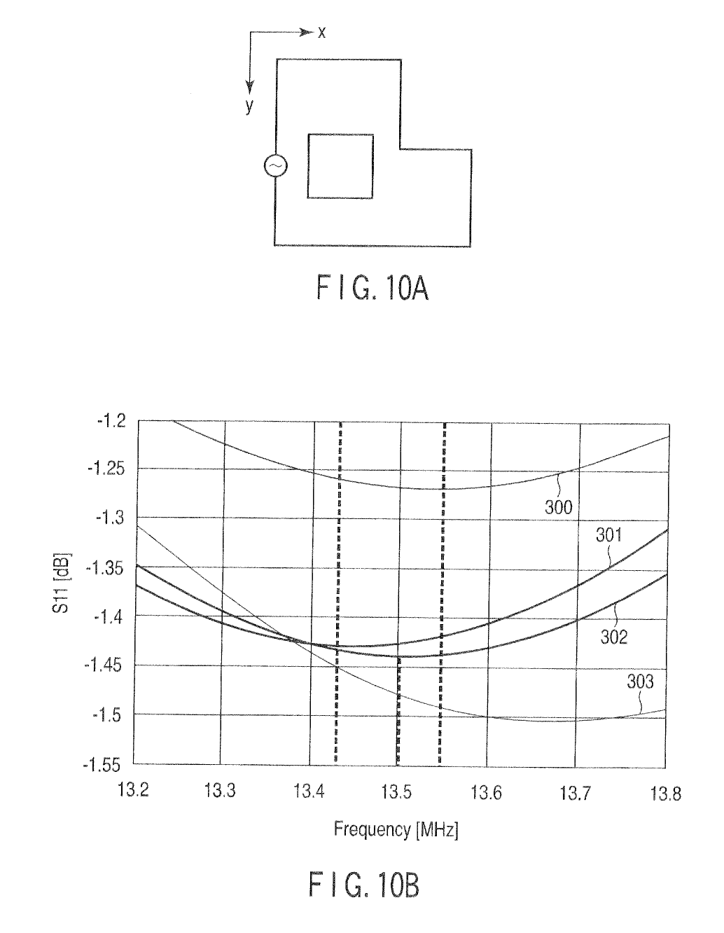

In this simulation, the target loop antenna has an asymmetrical form as illustrated in FIG. 10A. The loop antenna of FIG. 10A is provided with a feed point near the middle of its left edge. In this simulation, the change of the resonance frequency is measured by changing the position a 15-mm-square metal plate on the loop antenna of FIG. 10A. In FIG. 10B, 300 represents frequency characteristics of the loop antenna without a metal plate arranged thereon; 301 represents frequency characteristics of the loop antenna with the metal plate arranged at its center (the communication center estimated in accordance with the aforementioned method); 302 represents frequency characteristics of the loop antenna with the metal plate arranged at position shifted +7.5 mm in the y-direction from its center; and 303 represents frequency characteristics of the loop antenna with the metal plate arranged at a position shifted −7.5 mm in the y-direction from its center.

Similar to the results of the simulations according to the first embodiment, it is found from this simulation that the change of the resonance frequency can be suppressed with the arrangement of the metal plate at a position shifted from the center, in comparison with the arrangement of the metal plate at the center of the loop antenna.

As explained above, in the communication apparatus according to the present embodiment, the geometrical gravity point of the largest symmetrical form of symmetrical forms that can be cut out of the asymmetrical form of the loop antenna is assumed as the communication center of the wireless communication unit incorporating the loop antenna. Hence, in the communication apparatus according to the present embodiment, even when the loop antenna takes an asymmetrical form, the communication center of the wireless communication unit incorporating the loop antenna can be easily estimated, and the same effects as in the first embodiment can be attained.

### Third Embodiment

The third embodiment of the present invention relates to the implementation of the aforementioned communication apparatus (especially the coupler and the loop antenna) according to the first and second embodiments. The first and second embodiments have dealt with the arrangement of the coupler and the loop antenna. According to the present embodiment, a specific implementation of the coupler and the loop antenna will be discussed.

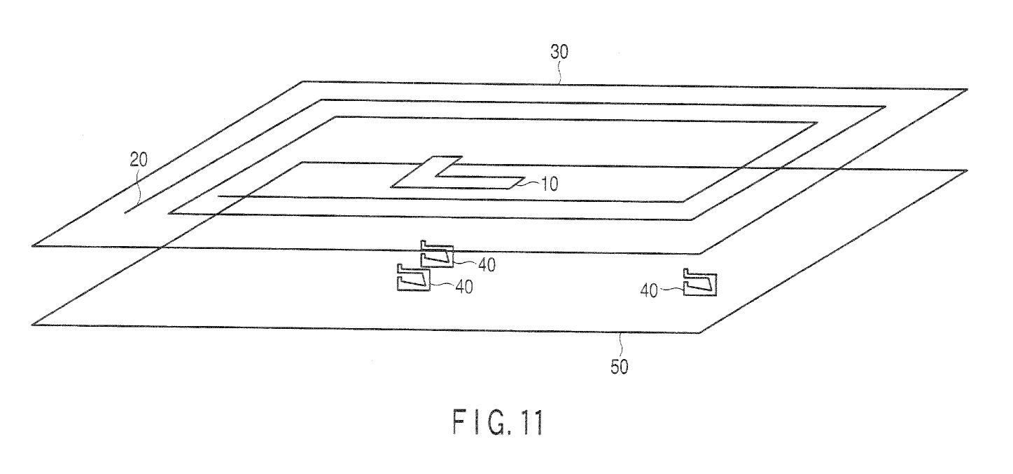

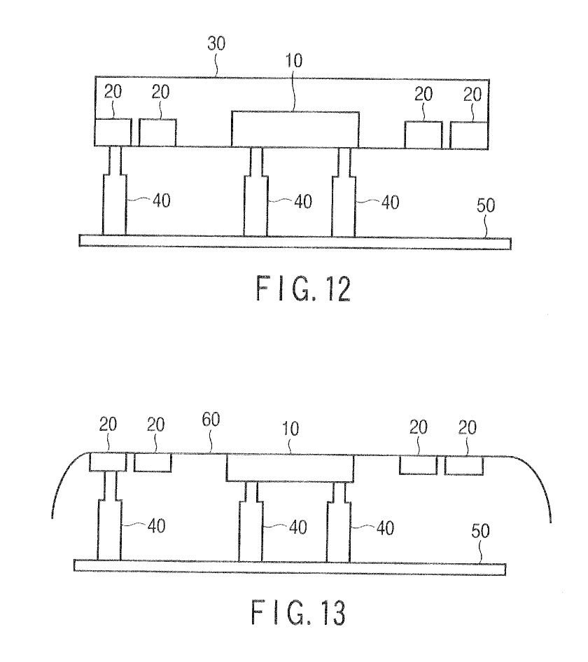

As illustrated in FIGS. 11 and 12, a coupler 10 and a loop antenna 20 may be formed on the same plane on a flexible printed circuit board 30, a film substrate or the like. When the coupler 10 and the loop antenna 20 are formed in such a manner, the flexible printed circuit board 30 or the film substrate is arranged between the housing of the communication apparatus or the like (not shown in the drawings) and a substrate 50. The coupler 10 and the loop antenna 20 are supplied with power from the substrate 50 by way of the feed spring 40.

Furthermore, as illustrated in FIG. 13, the coupler 10 and the Loop antenna 20 may be printed on the housing 60 of the communication apparatus or the like. In such en arrangement, power can be supplied by way of the feed spring 40 from the substrate 50 that opposed to the housing 60.

As explained above, in the communication apparatus according to the present embodiment, the coupler and the loop antenna are formed on the same plane of the flexible printed circuit board, or they are printed on the housing of the communication apparatus. Thus, the coupler and the loop antenna designed according to the first and second embodiments can be implemented in the communication apparatus according to the present embodiment, at low cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

A communication apparatus has been explained in the first to third embodiments, but a person skilled in the art would be able to design an antenna apparatus separately from a communication apparatus by arranging a loop antenna and a coupler in accordance with the above explanation. In other words, an antenna apparatus incorporating the coupler and the loop antenna according to the above explanation is included in the scope of the present invention.

What is claimed is:

1. A communication apparatus comprising a coupler for first wireless communication and a loop antenna for second wireless communication, wherein:
the coupler is electrically asymmetrical, and arranged in such a manner that a feed point substantially coincides with a center position of the second wireless communication.

2. The apparatus according to claim 1, wherein:
the loop antenna takes a symmetrical form; and
the coupler is arranged in such a manner that the feed point substantially coincides with a geometrical gravity point of the symmetrical form.

3. The apparatus according to claim 2, wherein:
the loop antenna takes a rectangular form; and
the coupler is arranged in such a manner that the feed point substantially coincides with an intersection point of diagonals of the rectangular form.

4. The apparatus according to claim 2, wherein:
the loop antenna takes an elliptical form; and
the coupler is arranged in such a manner that the feed point substantially coincides with an intersection point of a long axis and a short axis of the elliptical form.

5. The apparatus according to claim 1, wherein:
the loop antenna takes an asymmetrical form; and
the coupler is arranged in such a manner that the feed point substantially coincides with a geometrical gravity point, of the asymmetrical form.

6. The apparatus according to claim 5, wherein:
the loop antenna takes the asymmetrical form of which a symmetrical form can be cut out along a cutout line; and
the coupler is arranged in such a manner that the feed point, substantially coincides with a geometrical gravity point of the symmetrical form that is cut out of the asymmetrical form in such a manner as to have the largest area.

7. The apparatus according to claim 6, wherein:
the loop antenna takes the asymmetrical form of which a rectangular form can be cut out along the cutout line; and
the coupler is arranged in such a manner that the feed point substantially coincides with an intersection point of diagonals of the rectangular form that is cut out of the asymmetrical form in such a manner as to have the largest area.

8. The apparatus according to claim 1, wherein:
the coupler and the loop antenna are formed on the same plane.

9. The apparatus according to claim 1, wherein:
the coupler and the loop antenna are printed on a housing of the communication apparatus.

10. An antenna apparatus comprising a coupler for first wireless communication and a loop antenna for second wireless communication, wherein:
the coupler is electrically asymmetrical, and arranged in such a manner that a feed point substantially coincides with a center position of the second wireless communication.

11. The apparatus according to claim 10, wherein:
the loop antenna takes a symmetrical form; and
the coupler is arranged in such a manner that the feed point substantially coincides with a geometrical gravity point of the symmetrical form.

12. The apparatus according to claim 11, wherein:
the loop antenna takes a rectangular form; and
the coupler is arranged in such a manner that the feed point substantially coincides with an intersection point of diagonals of the rectangular form.

13. The apparatus according to claim 11, wherein:
the loop antenna takes an elliptical form; and
the coupler is arranged in such a manner that the feed point substantially coincides with an intersection point of a long axis and a short axis of the elliptical form.

14. The apparatus according to claim 10, wherein:
the loop antenna takes an asymmetrical form; and
the coupler is arranged in such a manner that the feed point substantially coincides with a geometrical gravity point of the asymmetrical form.

15. The apparatus according to claim 14, wherein:
the loop antenna takes the asymmetrical term of which a symmetrical form can be cut out along a cutout line; and
the coupler is arranged in such a manner that the feed point substantially coincides with a geometrical gravity point of the symmetrical form that is cut out of the asymmetrical form in such a manner as to have the largest area.

16. The apparatus according to claim 15, wherein:
the loop antenna takes the asymmetrical form of which a rectangular form can be cut out along the cutout line; and
the coupler is arranged in such a manner that the feed point substantially coincides with an intersection point of diagonals of the rectangular form that is cut out of the asymmetrical form in such a manner as to have the largest area.

17. The apparatus according to claim 10, wherein:
the coupler and the loop antenna are formed on the some plane.

18. The apparatus according to claim 10, wherein:
the coupler and the loop antenna are printed on a housing of the antenna apparatus.
